(19) United States
(12) Patent Application Publication
(10) Pub. No.: US 2026/0216957 A1
(43) Pub. Date: Jul. 30, 2026

(54) 3D PEN FOR PRODUCING THREE-DIMENSIONAL OBJECTS FROM THERMOPLASTIC MATERIAL

(71) Applicant: EDUSTICK SPÓLKA Z OGRANICZONA ODPOWIEDZIALNOSCIA, Warszawa (PL)

(72) Inventors: Mateusz Maciej MAZURKIEWICZ, Warszawa (PL); Damian WIERBILOWICZ, Warszawa (PL); Maciej Krzysztof MAZURKIEWICZ, Warszawa (PL)

(21) Appl. No.: 19/236,943

(22) Filed: Jun. 12, 2025

(30) Foreign Application Priority Data
Aug. 5, 2024 (PL) P.449458

(51) Int. Cl. B29C 64/209; B29C 64/295; B33Y 30/00

(52) U.S. Cl. CPC B29C 64/209; B29C 64/295; B33Y 30/00

(57) ABSTRACT

A 3D pen for producing three-dimensional objects from thermoplastic material which includes a bottom and top housing, a heater, a heater cover, a nozzle, a tube for thermoplastic material, an operation controller board and a power supply socket with a motor and a gear reducer. All constitute a separate power supply module inserted in a cut-out in the top housing by means of catches, the tube for thermoplastic material comprising two sections: a rear tube placed between the rear face of the lower housing and the gear reducer, and a front tube placed between the motor and the nozzle.

A 3D pen for producing three-dimensional objects from thermoplastic material.

The object of the invention is a 3D pen for producing three-dimensional objects from a thermoplastic material.

The principle behind today's 3D printing pens is essentially based on the print heads used in 3D printers, which were developed in the mid-1980s (creator Chuck Hull), and the technique for depositing the fused material was developed towards the end of those years (creator Scott Crump). In the middle of the first decade of the 21st century, a 3D printer for domestic use was designed (by Adrian Bowyer). In contrast, 3D pens were designed at the beginning of the second decade of the 21st century, according to some sources by Peter Dilworth and Maxwell Bogue of Wobbleworks. It should be noted that the aforementioned developers designed the devices, however, they were not the authors of 3D printing. This is particularly true about 3D printing and 3D pens.

Known from the U.S. Pat. No. 1,619,817A, the tool has a heating element which is removed from the wax storage or the tank structure. Then, the wax is inserted into the tube through an opening, being advantageously in the form of moulded sticks. The wax charge heated by a heating element connected to an electrical circuit melts and is applied to the material.

Known from the U.S. Pat. No. 2,272,780A, a marking apparatus that can be used to apply a coloured liquid to fabrics or other articles in order to mark them in any desired manner is provided with a fusible marker compound. It is normally in a solid state but it is reduced to a liquid state for use, by means of an electrical heating element incorporated in this apparatus. The device is equipped with a nozzle having a liquid chamber to receive the molten compound, which is released once it is ready through a ball valve at the end of the device. The invention also includes the means for feeding a fusible compound into an electric heater.

Known from the U.S. Pat. No. 2,567,960A as a pistol-type apparatus for melting and extruding plastic material, the apparatus is primarily intended for use in the manufacture of fishing flies by applying melted plastic material to fishing hooks to form them to simulate the body, limbs or antennae, and other insect representatives. The primary aim of the invention is to provide a relatively simple and effective device of the above type, by means of which the plastic material can be easily melted and easily applied to hooks or other objects as required.

Known from the European Patent Description No. EP2928672B1 (the priority from the U.S. Pat. No. 9,102,098B2), a three-dimensional (3D) drawing device having a housing adapted to be manipulated by the user's hand and to receive a raw material, which in some examples of implementation is a strip of thermoplastic material. The drawing device has a nozzle assembly with an outlet nozzle and a motor connected to a gearbox that couples to a band of thermoplastic raw material in such a way that the rotation of the motor causes the raw material to be extruded from the outlet nozzle to form a three-dimensional object.

Known from the Chinese Patent Description No. CN103341975A, the 3D printing pen consists of a body, spray head, heating cavity, motor device, transport tube, control board and key board, with the spray head, heating cavity, motor device, transport tube, control board and key board, all placed in the machine housing.

Known from the Chinese Patent Description No. CN103707511A, the 3D printing pen consists of a housing with an outlet at the upper end and a heat removal mechanism, a feeding mechanism, a fan, a feed tube and a control mechanism, all of which are placed in the housing, while a control mechanism is used to properly control the operation of the heat removal mechanism, the feeding mechanism and the fan.

Known from the Chinese Patent Description No. US10040235B2, the extrusion device includes a fibre coupling mechanism that pushes the fibre received by the device through a heater and a nozzle. The user can manipulate the movable control while operating the machine to change the extrusion speed. The extrusion device can operate in continuous flow mode. The extruder can be configured to operate with low electricity consumption.

Known from the U.S. Patent Description No. US20180281281A1, the 3D pen has a housing, a material feeding device, a heating device and a control chip; the housing has a material feeding hole; the material feeding device has a material feeding motor, a motion transfer mechanism and a material feeding mechanism; the material feeding motor is positioned longitudinally along the jacket; a single-start worm is located on the rotation axis of the material feeding motor; the single-start worm is connected to the motion transfer mechanism; the material feed mechanism has a material feed gear and an auxiliary wheel; the motion transfer mechanism is connected to the material feed gear; a wire feed gap is provided between the material feed gear and the auxiliary wheel; the heating device has a nozzle and a heating cavity; the material feed motor and the heating chamber are electrically connected to the control chip.

Known from the U.S. Pat. No. 11,590,704B1, the 3D drawing system includes a feed channel, a heater, a filament displacement system and a controller that includes a control circuit and a finger detector electrically connected to the control circuit. However, when the finger detector detects the presence of a user's finger that is aligned with the finger detector, the control circuit initiates operation of the filament displacement system to feed the filament into the heater along the feed channel, so that the filament is heated and melted by the heater to produce the flow of molten material.

The disclosed 3D printing pens are similar in design and mainly consist of a body ending in a nozzle, a heating zone, a tube feeding the stick material (usually referred to as filament), a control panel and buttons, transport elements (rollers, gears) and a drive (usually a stepper motor). All the components of the device/pen are fused together and housed in a case. If the motor or gearbox feeding the material fails, the unit is either discarded or requires expensive repair by a specialist.

The purpose of the invention is to develop a 3D pen for producing three-dimensional objects from a thermoplastic material, in which the motor and gear reducer is a separate power module inserted into a cut-out in the upper housing.

A 3D pen for producing three-dimensional objects from thermoplastic material according to the invention comprising a bottom and an upper housing, a heater, a heater cover, a nozzle and an operation controller board and a power supply socket, characterised in that the motor and the gear reducer constitute a separate power supply module, which is inserted into a cut-out in the upper housing by means of hooks, the tube for the thermoplastic material consisting of two sections, the rear tube placed between the rear face of the lower housing and the gear reducer and the front tube placed between the motor and the nozzle.

The object of the invention is illustrated in an example of implementation in the figure, which shows:

FIG. 1 The perspective view of the bottom housing and module with exposed motor and gear reducer;

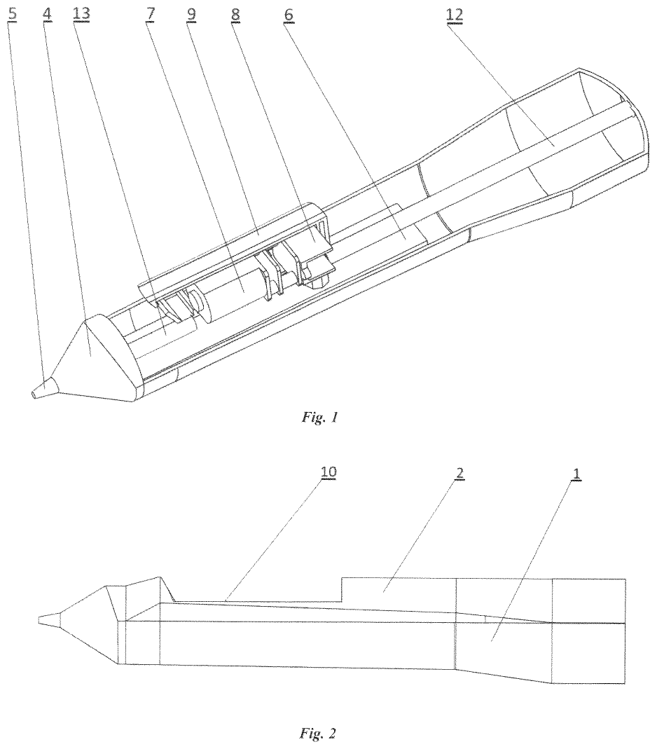

FIG. 2 The rectangular view of the housing with visible cut-out for the power supply module;

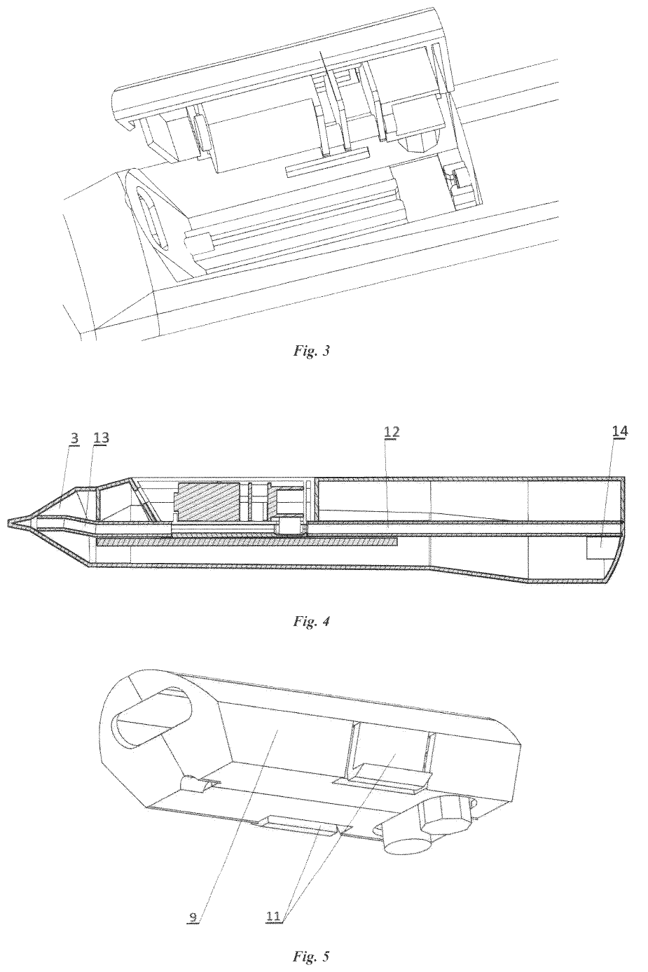

FIG. 3 The perspective view of a section of the upper housing and a section of the power module;

FIG. 4 a pen's cross-section;

FIG. 5 The perspective view of the power supply module;

The example of performance.

A 3D pen for producing 3D objects from thermoplastic material has a bottom housing (1) and a top housing (2), a heater (3), a heater cover (4), a nozzle (5), operation controller board (6) and power supply socket (14), and a motor (7) and gear reducer (8) in the form of a separate power supply module (9) placed in a cut-out (10) in the upper housing (2) by means of hooks (11), while inside the housing there are two sections of tubing for the thermoplastic material: a rear tube (12) positioned between the rear face of the lower housing (1) and the gear reducer (8), and a front tube (13) positioned between the motor (7) and the nozzle (5).

Unlike a standard device for producing three-dimensional objects from thermoplastic material, the disclosed 3D pen, thanks'to the use of a separate power supply module, allows that module to be quickly replaced directly by literally any user. This is particularly important in the event of failure of the motor or gearbox feeding the material. Usually, the device was either discarded or required an expensive repair by a specialist. This solution not only results in significant material savings, but also protects the environment (e.g. by reducing waste, reducing the need to manufacture basic pen components), making this invention an environmentally friendly solution.

1. A 3D pen for producing three-dimensional objects from thermoplastic material comprising a bottom housing (1) and a top housing (2), a heater (3), a heater cover (4), a nozzle (5), a tube for thermoplastic material, an operation controller board (6) and a power supply socket (14), characterised by a fact that a motor (7) and a gear reducer (8) form a separate power unit (9) placed in a cut-out (10) in the upper housing (2) by means of hooks (11), the tube for thermoplastic material consisting of two sections: a rear tube (12) positioned between a rear face of a lower housing (1) and the gear reducer (8), and a front tube (13) positioned between the motor (7) and the nozzle (5).
